(19) United States
(12) Patent Application Publication
(10) Pub. No.: US 2012/0239667 A1
(43) Pub. Date: Sep. 20, 2012

(54) KEYWORD EXTRACTION FROM UNIFORM RESOURCE LOCATORS (URLS)

(75) Inventors: Santosh R. Vysyaraju, Bengalore (IN); Uppinakuduru Raghavendra Udupa, Mysore (IN); Abhijit N. Bhole, Ahmedabad (IN); Guy Dassa, New Rochello, NY (US); Weiguo Liu, Dublin, CA (US); Qing Xiao, Burlingame, CA (US)

(73) Assignee: MICROSOFT CORPORATION, Redmond, WA (US)

(21) Appl. No.: 13/048,678

(22) Filed: Mar. 15, 2011

(51) Int. Cl. G06F 17/30

(52) U.S. Cl. 707/749; 707/E17.115; 707/E17.108

(57) ABSTRACT

The keyword extraction technique described herein extracts keywords from Uniform Resource Locators (URLs) in web logs. The technique leverages the content and the structure of URLs to extract relevant keywords. First, a URL is divided into multiple components based on its structure. A set of keywords are extracted from each component of the URL independently with the help of a controlled vocabulary. Then a second set of keywords are generated by forming combinations of terms from different segments of the URL. Only those combinations which are present in the controlled vocabulary are retained as keywords. Finally, the keywords are scored with a function which took into account of a wide set of features.

### BACKGROUND

In computing, a Uniform Resource Locator (URL) is a Uniform Resource Identifier (URI) that specifies where an identified resource is available and provides a mechanism for retrieving it. For example, a URL can be a unique identity given to a web page by the creator of a website hosting the web page. URLs are defined in a standard format which typically specifies a scheme or protocol, a domain name or Internet Protocol (IP) address, a path of the resource to be fetched or the program to be run, a query string and an optional fragment identifier. Increasingly, URLs contain condensed text that is highly relevant to the topic of the web pages they correspond to. They can be seen as a valuable source of information about the topic of a web page in many applications.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The keyword extraction technique described herein extracts keywords from URLs in web logs (e.g., server logs that contain a series of URL entries requested by a user, typically in reverse chronological order). The technique leverages the content and the structure of URLs to extract relevant keywords. In one embodiment, a URL is first divided into multiple components based on its structure. A set of keywords is extracted from each component of the URL independently with the help of a controlled vocabulary. A second set of keywords is generated by forming combinations of terms from different segments of the URL. Only those combinations which are present in the controlled vocabulary are retained as keywords. Finally, the keywords are scored with a function which take into account of a wide set of features.

### DESCRIPTION OF THE DRAWINGS

The specific features, aspects, and advantages of the disclosure will become better understood with regard to the following description, appended claims, and accompanying drawings where:

FIG. 1 depicts a flow diagram of an exemplary process of the keyword extraction technique described herein.

FIG. 2 depicts a flow diagram of another exemplary process of the keyword extraction technique described herein.

FIG. 3 is an exemplary architecture for practicing one exemplary embodiment of the keyword extraction technique described herein.

FIG. 4 is a schematic of an exemplary computing environment which can be used to practice the keyword extraction technique.

### DETAILED DESCRIPTION

In the following description of the keyword extraction technique, reference is made to the accompanying drawings, which form a part thereof, and which show by way of illustration examples by which the keyword extraction technique described herein may be practiced. It is to be understood that other embodiments may be utilized and structural changes may be made without departing from the scope of the claimed subject matter.

### 1.0 Keyword Extraction Technique

The following sections provide an overview of the keyword extraction technique, as well as exemplary processes and an exemplary architecture for practicing the technique. Details of various embodiments of the keyword extraction technique are also provided.

1.1 Overview of the Technique

The keyword extraction technique described herein extracts keywords from URLs. The technique uses the content and the structure of URLs to extract relevant keywords. These keywords can then be used in various applications, such as, for example, on-line advertising and on-line content filtering.

1.2 URL Structure

Since the present keyword extraction technique uses the URL structure in extracting keywords, some explanation of URL structure is useful. A URL's format is based on Unix file path syntax, where forward slashes are used to separate directory or folder and file or resource names. Every URL consists of some of the following: the scheme name (commonly called protocol), followed by a colon, then, depending on the scheme, a domain name (alternatively, Internet Protocol (IP) address), a port number, the path of the resource to be fetched or the program to be run, a query string, and an optional fragment identifier. The syntax is scheme://domain:port/path?query_string#fragment_id. The keyword extraction technique described herein uses this URL format to extract keywords for web pages, which can be used for various applications. It is not necessary for the web page to be downloaded in order to extract the keywords for the web pages that correspond to the extracted keywords. This provides great computational efficiency.

1.3 Exemplary Processes

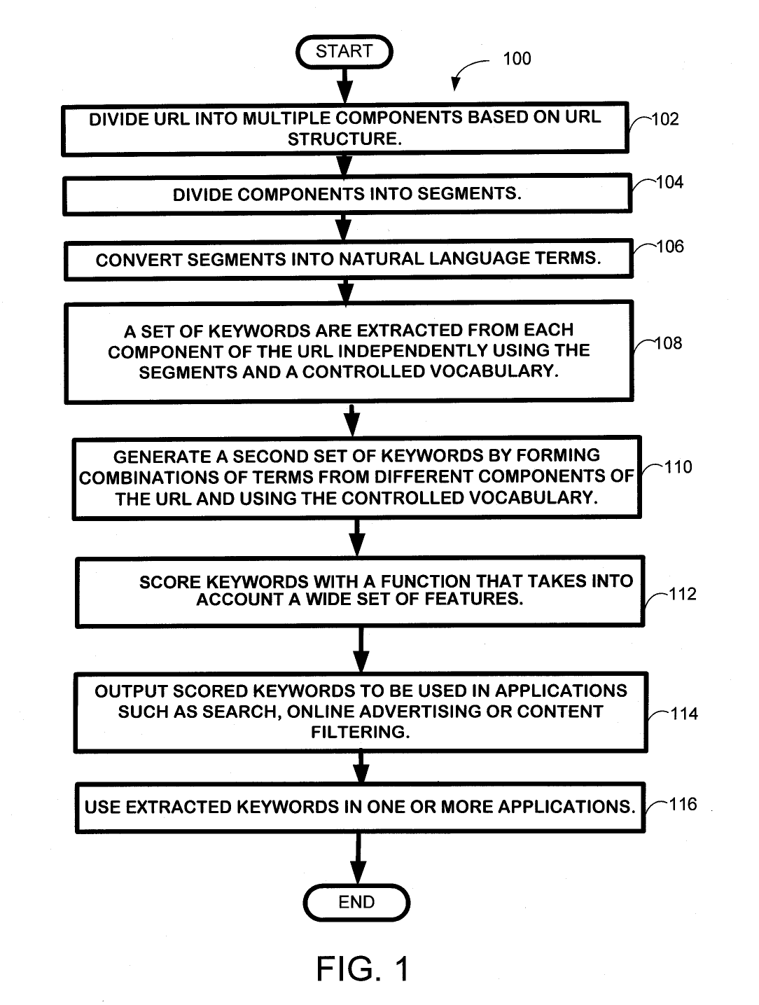

FIG. 1 depicts an exemplary computer-implemented process for extracting keywords from URLs. As shown in FIG. 1, block 102, the components of the URL are identified. More specifically, in one embodiment of the keyword extraction technique, the URL is divided into authority, path, query and fragment components.

The identified components are then broken down into segments, as shown in block 104. For example, the authority component is broken into segments by discarding a protocol field and an extension field for the authority component; while the path component is broken into segments by discarding all fields not related to the topic of the web page to which the URL corresponds. The query component is broken into segments by extracting key-value pairs in the query field, and the fragment component is broken into segments by extracting a fragment field. The segmentation of the keywords will be discussed in greater detail later in this specification.

The segments are then processed by performing text segmentation on the segments to convert URL text into natural language terms, as shown in box 106. For example, in one embodiment, this is done by replacing each delimiter in the URL text with a space to create terms; and then splitting terms commonly found in URLs.

A first set of keywords is then extracted from the segment terms based on a controlled vocabulary, as shown in block 108. Terms in the segments that match the controlled vocabulary are held to belong to the first set of keywords. The controlled vocabulary is large list of valid terms and phrases that could be extracted from any URL. A second set of keywords is also generated by forming combinations of terms from different segments of the URL than were used to generate the first set of keywords based on the controlled vocabulary, as shown in block 110. In one embodiment of the technique, this second set of keywords is extracted by combining pairs of segments of the URL to generate candidate keyword combinations and taking a keyword each from the pair of segments by concatenating the keyword from each of the pair of segments and then verifying the candidate keyword combinations against the controlled vocabulary. Candidate keyword combinations found in the controlled vocabulary are extracted as keywords and those that are not found are excluded. The keywords extracted from the URL can also be optionally expanded by using an external knowledge source. For instance, with a semantic mapping, “travel” can be expanded to “trip” and “tour”.

As shown in block 112, the relevance of the first and second sets of keywords is then scored based on a set of features, and the scored keywords are output in order of relevance (block 114). In one embodiment of the keyword extraction technique each keyword is scored based on the position of its parent segment, length of the keyword, and length of the parent segment.

The output keywords can then be used in various applications, as shown in block 116. For example, the extracted keywords can be used to match keywords on a web page with keywords provided by advertisers related to advertisements in order to target specific types of advertisements to specific types of websites. It should be noted that it is not necessary to download the web page in order to extract the keywords from a given web page. Alternately, the extracted keywords can be used for content filtering, for example to filter content, such as pornography, by matching keywords extracted from a web page with a list of terms or phrases that are objectionable. The extracted keywords can also be used for search applications by matching the extracted keyword for a web page with search query terms.

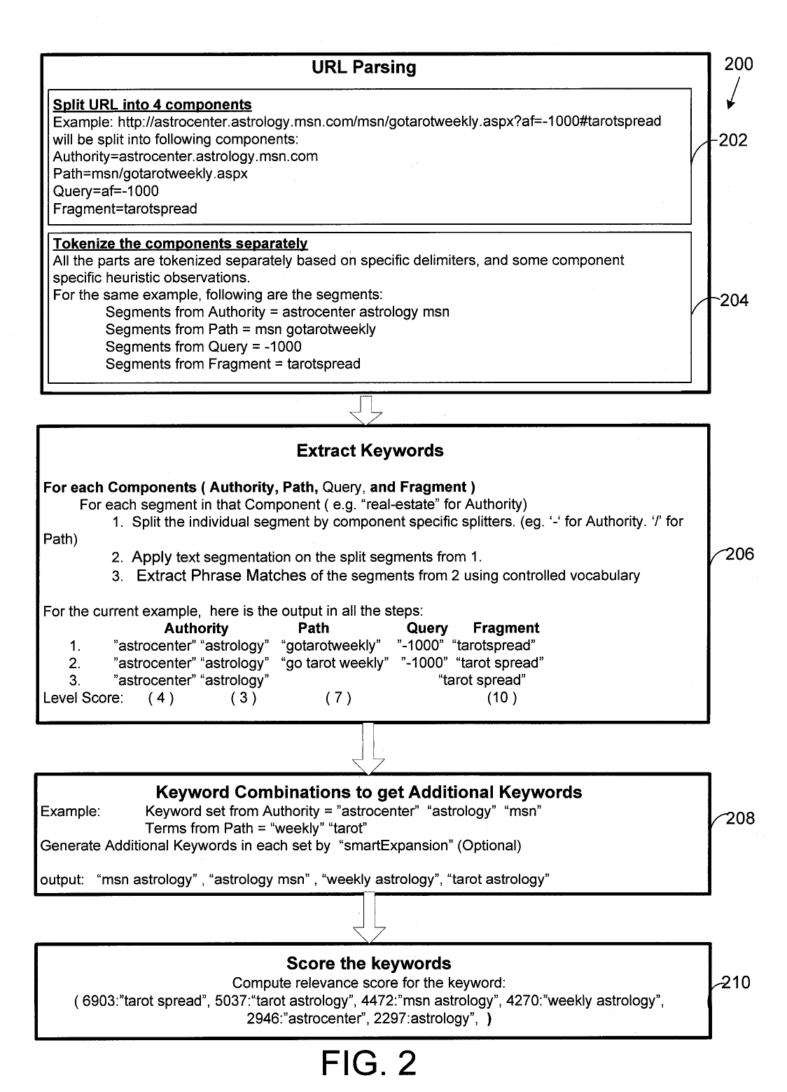

FIG. 2 depicts another exemplary computer-implemented process 200 for extracting keywords from URLs according to the technique. FIG. 2 provides the general process actions of this exemplary process. More details on these process actions are provided later in the specification.

As shown in FIG. 2, block 202, a URL of a web page is divided into four pre-defined URL components of authority, path, query and fragment. The components are tokenized separately based on specific delimiters and heuristic observations to obtain segments, as shown in block 204. As shown in block 206, text segmentation is performed on the segments to convert the URLs' text into natural language terms and a first set of keywords is extracted from the segment terms based on a controlled vocabulary. As shown in block 208, a second set of keywords is generated by forming combinations of terms from different segments of the URL used to extract the first set of keywords and extracting combinations of terms that are in the controlled vocabulary as the second set of keywords.

These first and second sets of keywords are then scored based on relevance in order to output an ordered set of scored keywords, as shown in block 210. Various scoring techniques can be used for this purpose. The technique can also generate additional keywords by using an external knowledge source to provide expansion of the keywords by mapping the keywords to other semantically equivalent or related words and phrases.

1.4 Exemplary Architecture

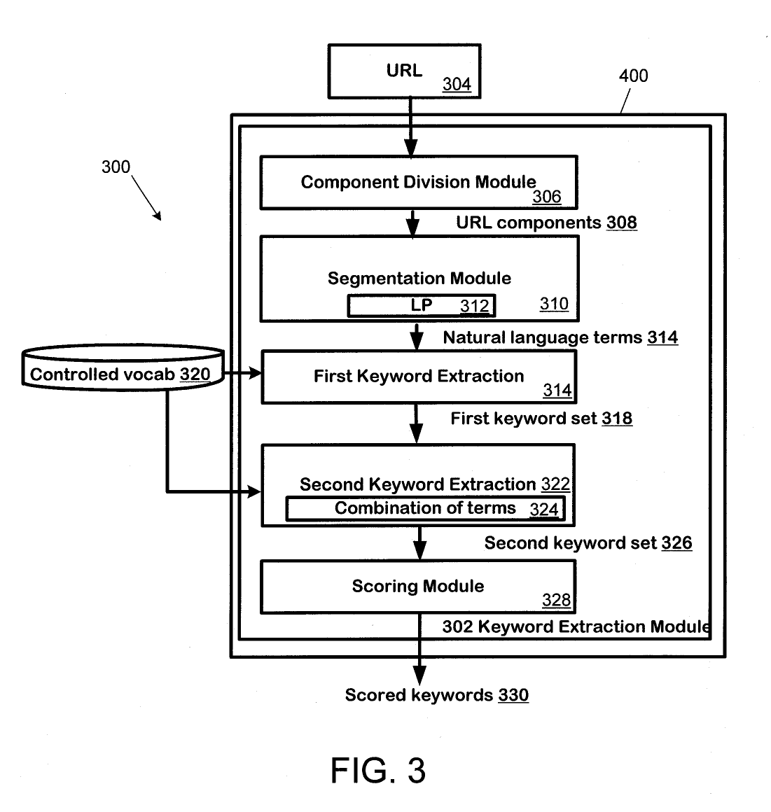

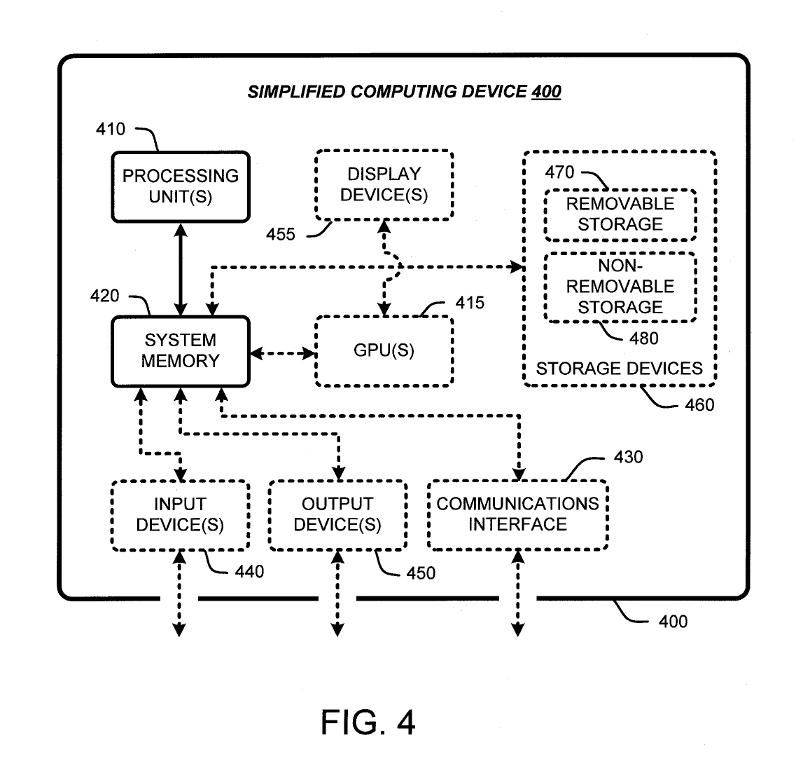

FIG. 3 shows an exemplary architecture 300 for employing the keyword extraction technique. As shown in FIG. 3, this exemplary architecture 300 includes a keyword extraction module 302 that resides on a general purpose computing device 400, which will be discussed in greater detail with respect to FIG. 4. A URL 304 is input. A component division module 306 divides the URL 304 into multiple components 308 based on URL structure. This set of components 308 is segmented in a segmentation module 310 and the segments are converted to natural language speech terms 314 in a language processing module 312. A first set of keywords 318 is then extracted from each component of the URL independently in a first keyword extraction module (block 316) using a controlled vocabulary (block 320). A second set of keywords (block 326) is also extracted in a second keyword extraction module (block 322) by forming combinations of terms 324 from different segments of the URL than were used to extract the first set of keywords and retaining only keywords that are present in the controlled vocabulary (block 320). The first and second keywords 316, 326 are then scored in a scoring module (block 328). In one embodiment of the keyword extraction technique the keywords are scored based on the location in the URL from which they were extracted. The scored keywords 330 are then output for use with one or more applications.

Details for aspects of this architecture will be discussed in the next section.

1.5 Details of Exemplary Embodiments of the Keyword Extraction Technique

Exemplary processes and an exemplary architecture having been discussed, the following sections provide details of various embodiments of the keyword extraction technique.

1.5.1 URL Parsing

URL parsing is one of the first steps in keyword extraction where informative parts in the URL are retained and noisy text is skipped. This is achieved by leveraging the structure of the URL. As discussed previously, URLs generally contain four important components: authority, path, query and fragment. The general extraction of the components from the URL is discussed in greater detail in the paragraphs below. Each of the extracted components is further parsed into segments.

1.5.1.1 Authority

Authority is a necessary component in every URL. It gives the name of the server on which the page representing the URL is hosted. Authority may contain multiple parts such as protocol, hostname, domain separated by dots. Authority always starts with a protocol such as “http”, ‘https”. Also, the last part in the authority takes one among the values of “com’, “net”, “us’, “org” etc which broadly indicates the kind of website and is not typically useful in finding relevant keywords. The technique discards both the protocol and the last part of the URL and retains the remaining parts as segments from this component. For example, “http://realestate.msn.com” has the segments “realestate” and “msn”.

1.5.1.2 Path:

A URL may contain a path field which contains the path to the resource to be fetched. The path field follows authority in the URL and may contains a list of directories separated by “/”. These directories might represent the categories to which the page corresponding to the URL belongs to. Sometimes, directories can contain non-informative text like “content” or a series of digits which have no relation to the topic of the page. These directories are ignored and the remaining directories constitute the segments for this component. For example, these directories may be ignored if the text is too generic (i.e., “content”, “file”) or non-informative (i.e., “123”, “a”).

1.5.1.3 Query:

Sometimes URLs point to a web application such as search engine and Common Gateway Interface (CGI) scripts. The query field is the query string that is sent as input to these programs. The query field starts with a “?” after the path in the URL. A query field contains key-value pairs with delimiters “;”, “&”, and so forth. Key-value pairs are a set of two linked data items: a key, which is a unique identifier for some item of data; and the value, which is either the data that is identified or a pointer to the location of that data. For example, city=“las vegas”&show=“cirque du soleil” means that the Cirque du Soleil performance is in the city of Las Vegas. Key-value pairs in the query string are retained as segments from this component. Depending on the application some keys may become important and some other keys may become noise.

1.5.1.4 Fragment:

The fragment field is the HTML anchor that appears at the end of the URL after the pound sign, “#”. The fragment field is retained as segments from this component.

All the segments derived from the four logical components form the base unit for the keyword extraction technique to operate on.

1.5.2 Controlled Vocabulary

It is difficult to find phrase boundaries from the unstructured text in the URLs as there is no rule on how text should appear. Existing Natural Language Processing (NLP) tools for phrase identification such as Name Entity Recognizers (NER), Part of Speech (POS) taggers cannot be applied here as they are trained on the free flow of natural language text. To overcome this challenge, the keyword extraction technique makes use of a controlled vocabulary to identify valid phrases in a URL.

In general, a controlled vocabulary is a large list of valid phrases that can be extracted from any URL. The nature and the size of the controlled vocabulary may vary depending upon the application for which the keywords are used. For example, a general topic identification system can use a generic topic list derived from Wikipedia topics as a controlled vocabulary. A keyword extraction system for advertising may use a list of millions of advertising bid phrases as controlled vocabulary.

1.5.3 Text Segmentation

Prior to keyword extraction, additional processes are required to convert segmented URL text to natural language text. In one embodiment, delimiters such as “-” or “_” are replaced with space and attached terms commonly found in URLs are split. For instance, “savinganddebt” will be split into “savings and debt”.

To optimize the relevance of the split terms, each split term is first checked to see if it is present in the controlled vocabulary. If it is not present, the technique tries to search for a valid split present in the controlled vocabulary. Term splitting is performed in an iterative fashion as follows.

1) One more space is introduced into the term (e.g., this can be done by trial and error in an iterative fashion until a match is found in the controlled vocabulary).

2) All possible splits of words with the new space are generated.

3) If one valid split is found, the terms of the valid split are returned.

4) If more than one valid split is found, for each valid split, the sum of frequencies of individual words in the controlled vocabulary is computed and the terms of the valid split with maximum sum is returned.

1.5.4 Keyword Extraction

After text segmentation, keywords are extracted from each segment by scanning the segment against a controlled vocabulary. A phrase from a segment is designated as keyword if it is present in the controlled vocabulary. In one embodiment of the keyword extraction technique, each segment is scanned from the left initially with the largest possible phrase, a length of 4 words. If match was found, the phrase is added to the list of keywords. Otherwise, the length of the phrase is reduced by one, to a length of 3 words, and the technique repeats the previous step. This process is reiterated till the technique finds a phrase in controlled vocabulary or the technique is left with the first word in the segment. Then the technique moves to the next word in the segment and repeats the same process to find phrases which might be keywords.

In one embodiment, along with the above keywords, an additional keyword is extracted if the URL is a search engine result page. A user query is extracted from the query component of the URL and output as a stand-alone keyword irrespective of whether the query is present in the controlled vocabulary or not.

1.5.4 Keyword Combinations

Keyword extraction from a URL does not yield many keywords because of the limited amount of text in the URL. One limitation of the keyword extraction process discussed with respect to the extraction of the first set of keywords is that the technique constructs keywords from only words appearing consecutively in the same segment of the URL. However, it is possible to generate relevant keywords by combining the terms from different segments of the URL. To achieve this, the technique implements the following.

First, a set of keywords are extracted from each segment in the URL using the method explained in the extraction step for the first set of keywords. For every pair of segments, candidate keyword combinations are formed by taking a keyword each from the two different segments and concatenating them. These candidate combinations are verified against the controlled vocabulary and those present in the controlled vocabulary are retained as keywords and others are discarded. The initial set of keywords extracted from the segments in the previous extraction step and the keywords generated from this combination step form the final set of keywords for a URL.

1.5.6 Smart Expansion

In one embodiment, the technique uses smart expansion to expand the keywords extracted from a URL. This embodiment uses an external knowledge source which provides keyword to related expansions mapping. For instance, semantically related terms could be created by experts. In such a mapping “auto insurance” could be mapped to “car insurance”. Expansions can be used during the above-discussed keyword combinations stage. After initial keyword sets are generated, additional keywords are retrieved and added for all keywords in each set using smart expansions. The rest of the combinations process is carried out as described in the previous section but on the new sets having the expansions.

1.5.6 Relevance Scoring

In one embodiment of the technique, a relevance score of a keyword is computed based on the position of its parent segment(s), length of the keyword and length of the parent segment(s). First, each keyword is assigned a value between 0 and 10, referred to as level, based on its position in the URL. The value of level increases as one moves from left to right in the URL. A keyword appearing in authority has less level than that of a keyword from Query (Fragment>Query>Path>Authority). The level of the keyword k is normalized using the length of the parent segment.

$$k \cdot level = \frac{k \cdot level * k \cdot len}{{\sum }_{i = 0}^{n - 1} {r}^{i}}$$

Where k.len is the length of the keyword, k.level is the level of the keyword and n is the length of the parent segment. If the keyword is a combination of two keywords k1 and k2, then the level of the keyword is normalized as the following.

$$k \cdot level = \frac{k 1 \cdot level * k 1 \cdot len + k 2 \cdot level * k 2 \cdot len}{{\sum }_{i = 0}^{k 1 + k 2} {r}^{i}}$$

The final relevance score of a keyword is computed in a range of 0 to 10,000. It is equal to the 1000 times the level of the keyword normalized by the maximum level possible for that URL. The relevance score of a keyword is given by

$$Relevance Score = \frac{log ( 1 + \frac{KeyLevel}{10} ) * 10000}{log ( 1 + \frac{MaxLevel}{10} )}$$

Depending on the applications the extracted keywords are used for, the relevance score can be further combined with other measures of keywords. These measures can be obtained in generating the control vocabulary. For example, in an advertising application, the number of bidding advertisers, the number of user views, clicks, conversion or price can all be important measurements to use.

1.5.6 Capturing User intent with Keyword Extraction from a Referrer URL

In some applications, keywords are extracted every time a user visits a web page to infer the user intent. In such scenarios, along with a web page's URL, it is also possible to make use of a referrer URL. The referrer URL is the URL of the previous web page from which the user requested the current page. It gives the context in which the user visited the current page. In one embodiment of the keyword extraction technique, when the referrer URL is also available along with the query URL, keywords are extracted from both of the URLs independently using the extraction method explained above. A final list of keywords is prepared by combining keywords from both URLs. If a keyword originated from both, the keyword having the highest score is retained and the other keyword is ignored.

### 2.0 Exemplary Operating Environments:

The keyword extraction technique described herein is operational within numerous types of general purpose or special purpose computing system environments or configurations. FIG. 4 illustrates a simplified example of a general-purpose computer system on which various embodiments and elements of the keyword extraction technique, as described herein, may be implemented. It should be noted that any boxes that are represented by broken or dashed lines in FIG. 4 represent alternate embodiments of the simplified computing device, and that any or all of these alternate embodiments, as described below, may be used in combination with other alternate embodiments that are described throughout this document.

For example, FIG. 4 shows a general system diagram showing a simplified computing device 400. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement the keyword extraction technique, the device should have a sufficient computational capability and system memory to enable basic computational operations. In particular, as illustrated by FIG. 4, the computational capability is generally illustrated by one or more processing unit(s) 410, and may also include one or more GPUs 415, either or both in communication with system memory 420. Note that that the processing unit(s) 410 of the general computing device may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 4 may also include other components, such as, for example, a communications interface 430. The simplified computing device of FIG. 4 may also include one or more conventional computer input devices 440 (e.g., pointing devices, keyboards, audio input devices, video input devices, haptic input devices, devices for receiving wired or wireless data transmissions, etc.). The simplified computing device of FIG. 4 may also include other optional components, such as, for example, one or more conventional computer output devices 450 (e.g., display device(s) 455, audio output devices, video output devices, devices for transmitting wired or wireless data transmissions, etc.). Note that typical communications interfaces 430, input devices 440, output devices 450, and storage devices 460 for general-purpose computers are well known to those skilled in the art, and will not be described in detail herein.

The simplified computing device of FIG. 4 may also include a variety of computer readable media. Computer readable media can be any available media that can be accessed by computer 400 via storage devices 460 and includes both volatile and nonvolatile media that is either removable 470 and/or non-removable 480, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Storage of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying the some or all of the various embodiments of the keyword extraction technique described herein, or portions thereof, may be stored, received, transmitted, or read from any desired combination of computer or machine readable media or storage devices and communication media in the form of computer executable instructions or other data structures.

Finally, the keyword extraction technique described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

What is claimed is:

1. A computer-implemented process for extracting keywords from Uniform Resource Locator (URL) corresponding to a website, comprising:
identifying the components of the URL;
dividing the URL into multiple segments based on the structure of the URL components;
performing text segmentation on the segments to convert URL text into natural language terms;
extracting a first set of keywords from the segment terms based on a controlled vocabulary;
generating a second set of keywords by forming combinations of terms from different segments of the URL than used to generate the first set of keywords based on the controlled vocabulary;
scoring the relevance of the first and second sets of keywords based on a set of features; and
outputting the scored keywords in order of relevance.

2. The computer-implemented process of claim 1 wherein dividing a URL into multiple segments based on the structure of the URL, further comprises:
dividing the URL into authority, path, query and fragment components.

3. The computer-implemented process of claim 2 wherein the authority component is broken into segments by discarding a protocol field and an extension field for the authority component.

4. The computer-implemented process of claim 2 wherein the path component is broken into segments by discarding all fields not related to the topic of the webpage to which the URL corresponds.

5. The computer-implemented process of claim 2 wherein the query component is broken into segments by extracting key-value pairs in the query field.

6. The computer-implemented process of claim 2 wherein the fragment component is broken into segments by extracting a fragment field.

7. The computer-implemented process of claim 1, wherein extracting the first set of keywords comprises:
(a) comparing a segment phrase of a length of four terms against the controlled vocabulary,
(b) designating the phrase as a keyword if the phrase is found in the controlled vocabulary,
(c) if a phrase is not found in the controlled vocabulary reducing the length of the segment by one term and comparing the phrase again against the controlled vocabulary,
(d) repeating (c) until the remaining terms are found in the controlled vocabulary or only one term of the phrase is left; and
(e) outputting the phrase as a keyword if it is found in the controlled vocabulary or disregarding the phrase if it is not found in the controlled vocabulary.

8. The computer-implemented process of claim 1, further comprising deleting combinations of terms from the second set of keywords which are not found in the controlled vocabulary.

9. The computer-implemented process of claim 1, wherein the 2 wherein the controlled vocabulary is large list of valid phrases that could be extracted from any URL.

10. The computer-implemented process of claim 1, wherein converting URL text to natural language text prior to extraction of the first set of keywords comprises:
replacing each delimiter in the URL text with a space to create terms; and
splitting terms commonly found in URLs.

11. The computer-implemented process of claim 10, wherein splitting terms further comprises:
introducing one more space into each term;
generating all possible splits with the new space;
if one valid split is found, return the valid terms of the split,
for each valid split, compute the sum of frequencies of individual words in a controlled vocabulary.
return the valid split terms with the maximum sum.

12. The computer-implemented process of claim 1 wherein generating a second set of keywords by forming combinations of terms from different components of the URL further comprises:
generating the first set of keywords;
combining pairs of segments from portions of the URL to generate candidate keyword combinations by taking a keyword each from the pair of segments by concatenating the keyword from each of the pair of segments;
verifying the candidate keyword combinations against a controlled vocabulary;
retaining candidate keyword combinations found in the controlled vocabulary as keywords, and if not found discarding the candidate keyword combinations.

13. The computer-implemented process of claim 1, further comprising expanding the keywords extracted from the URL by using an external knowledge source.

14. The computer-implemented process of claim 1 wherein the scoring the first and second sets of keywords based on a set of features, further comprises, scoring each keyword based of the position of its parent segment, length of the keyword, and length of the parent segment.

15. The computer-implemented process of claim 14 further comprising:
assigning each keyword a value level between 0 and 10 based on its position in the URL, wherein the value level increases from left to right in the URL;
normalizing the level of the keyword using the length of the parent segment; and
using the normalized level of each keyword to score the keyword thereby obtaining a relevance score.

16. A computer-implemented process for extracting keywords from Uniform Resource Locator (URL) addresses, comprising:
dividing a current URL of a current web page into four pre-defined URL components of authority, path, query and fragment;
tokenizing the components separately based on specific delimiters and heuristic observations to obtain segments;
performing text segmentation on the segments to convert the URL's text into natural language terms;
extracting a first set of keywords from the segment terms based on a controlled vocabulary;
generating a second set of keywords by forming combinations of terms from different segments of the URL from the first set of keywords based on the controlled vocabulary;
scoring the first and second sets of keywords based on relevance in order to output an ordered set of scored keywords.

17. The computer-implemented process of claim 16 wherein a relevance score for each keyword is determined based on the position in the URL from the segment from which the keyword is derived, the length of the keyword and the length of the segment from which the keyword is derived.

18. The computer-implemented process of claim 16 wherein referrer keywords are extracted from a referrer URL of a web page from which a user requested the current webpage and associated current URL, and wherein the keywords from both the current URL and the referrer URL are combined.

19. The computer-implemented process of claim 17 wherein if a same keyword is obtained from the current URL and the referrer URL the keyword with the highest relevance score is retained.

20. A system for generating keywords from the URL of a webpage, comprising:
a general purpose computing device;
a computer program comprising program modules executable by the general purpose computing device, wherein the computing device is directed by the program modules of the computer program to,
divide a URL into multiple components based on URL structure;
extract a first set of keywords from each component of the URL independently using a controlled vocabulary;
extract a second set of keywords by forming combinations of terms from different components of the URL that was used to extract the first set of keywords;
retain only keywords that are present in the controlled vocabulary;
score the keywords based on the location in the URL from which the keywords were extracted.
